(19) United States
(12) Patent Application Publication
(10) Pub. No.: US 2003/0054845 A1
(43) Pub. Date: Mar. 20, 2003

(54) Enhanced time of arrival estimation using reduced complexity optimal processing

(76) Inventors: Leonid Krasny, Cary, NC (US); Havish Koorapaty, Cary, NC (US)

Correspondence Address: COATS & BENNETT, PLLC, P O BOX 5, RALEIGH, NC, 27602, US

(21) Appl. No.: 09/943,551

(22) Filed: Aug. 30, 2001

(51) Int. Cl. H04B 7/005

(52) U.S. Cl. 455/506; 455/504; 455/59

(57) ABSTRACT

The time of arrival of a received signal with multipath components is precisely estimated using an optimal algorithm, such as Maximum Likelihood Estimation (MLE), after restricting the optimal algorithm's search space to one or more time intervals determined by preprocessing the received signal using a less computationally complex sub-optimal algorithm. This approach yields the accuracy benefits of optimal algorithm processing, while reducing aggregate computational complexity. Sub-optimal algorithms include but are not limited to correlation, MUSIC, and Signal-Eigen-Vector (SEV) processing. Iterative sub-optimal pre-processing of the received signal further refines the optimal algorithm search space, and, in some instances, may be used to resolve multipath time-of-arrival (TOA) with sufficient accuracy. Accurate received signal TOA determination enables precise positioning of wireless receivers, which has relevance across a broad range of applications, such as E-911 location services and navigational systems.

### BACKGROUND OF THE INVENTION

The present invention generally relates to wireless signal reception, and particularly relates to higher resolution techniques for estimating a signal's time-of-arrival.

Position determination finds broad utility across a range of applications, including emergency 911 (E-911) locating services, navigation systems, location-based information or marketing services, and others. Determining the position of a wireless receiver typically involves some type of triangulation approach involving time-of-arrival (TOA), direction-of-arrival (DOA), or other like technique, wherein the receiver determines appropriate parameters for signals received from three or more transmitters.

For example, a Global Positioning System (GPS) receiver determines the TOA for signals received from four or more GPS satellites to uniquely determine the receiver's latitude, longitude, and elevation. Wireless access terminals, such as the mobile radiotelephones used in modern wireless communication networks, may also derive their position through triangulation based on determining the TOA of signals received from three or more geographically separated radio base stations. Conversely, determining the TOA of the receiver's signal at each of the three radio base stations yields the same result. In any case, the accuracy of position estimation depends on the accuracy of TOA estimations.

Accurate TOA estimation entails a number of challenges. Some approaches to TOA estimation, while providing accurate, high-resolution estimates, are computationally too complex to yield accurate position estimates within the requisite times. For example, emergency locating requirements applied by the Federal Communication Commission to wireless network operators for 911 calls requires relatively accurate position determination (50-100 meters or less) within five seconds or less. In these circumstances, using highly accurate but potentially very slow TOA estimation algorithms is unacceptable.

Other challenges arise from the real-world vagaries of the typical received signal. What originates as a single transmit signal oftentimes arrives as a composite received signal comprising a plurality of multipath rays. Each multipath ray travels a different propagation path, and thus has different signal characteristics in terms of phase shift and attenuation, and, significantly, each ray has a different TOA with respect to the wireless receiver.

Thus, estimating TOA for the received signal entails processing the multipath signal such that at least the significant multipath components are resolved from the composite received signal. In some cases, the time separation between rays will be minimal, further complicating the task of resolving the multipath rays with enough resolution to satisfy the overall TOA estimation accuracy requirements of the positioning task at hand.

### BRIEF SUMMARY OF THE INVENTION

Received signal TOA estimation in accordance with at least some embodiments of the present invention combines sub-optimal and optimal received signal processing to approach the accuracy obtainable only with a pure optimal approach, while simultaneously reducing the aggregate computational complexity. Pre-processing the received signal with a sub-optimal algorithm reduces the search space within which the computationally more intensive optimal algorithm, such as Maximum Likelihood Estimation (MLE), is applied. The extent to which the search space is reduced or decreased in dimensionality depends on the particular sub-optimal approach taken. In general, sub-optimal processing restricts at least the time window or windows within which the optimal algorithm operates.

Thus, sub-optimal processing may be used to simply identify one or more time intervals over which the higher resolution optimal algorithm is applied. Depending upon the time separation of the multipath rays, sub-optimal processing may be used to identify the probable number of multipath rays in the received signal, and further to generate rough TOA estimates for those rays. Optimal processing may then operate at higher resolution within time windows defined around the estimated ray positions. MLE processing operates within these time windows to identify the most likely combination of ray arrival time by considering all permutations of ray position, amplitude, and phase for the one or more multipath rays involved. The position of the earliest ray corresponding to the Maximum Likelihood permutation may be taken as the TOA of the received signal.

Sub-optimal processing of the received signal may entail using any sub-optimal algorithm, with correlation, Multiple Signal Identification and Classification (MUSIC), and Signal Eigen Vector (SEV) approaches representing exemplary algorithms. In some cases, a sub-optimal algorithm is used iteratively to further refine TOA information in advance of optimal algorithm processing. For example, correlation processing may be performed iteratively, with successive cancellation of correlation peaks in each iteration cycle. This approach iteratively breaks the received signal down into its ray components, and may, in some instances, provide sufficient accuracy for TOA estimation absent any subsequent optimal processing. Of course, optimal processing may still be applied within time windows defined around one or more of the ray components.

### BRIEF DESCRIPTION OF THE DRAWINGS

FIG. 1 is a diagram of a wireless device receiving a transmitted signal as a composite of several multipath signals.

FIG. 2A is a diagram of multipath components in a received signal with relatively wide time separation.

FIG. 2B is a diagram of multipath components in a received signal with relatively narrow time separation.

FIG. 3 is a flow diagram of an exemplary approach to time of arrival estimation using a combination of sub-optimal and optimal algorithms.

FIGS. 4A-4C are diagrams illustrating the successively better resolution of correlation peaks in the received signal using iterative sup-optimal processing.

FIG. 5 is a flow diagram of iterative sub-optimal processing.

### DETAILED DESCRIPTION OF THE INVENTION

The present invention broadly applies to received signal TOA estimation. It is not limited to use in mobile terminal positioning within wireless communication networks, although the invention may be used to great advantage in such environments. Broadly, TOA estimation in accordance with the present invention applies to a wide range of signal types and systems.

In general, the present invention uses a sub-optimal algorithm to reduce or otherwise restrict the search space of an optimal algorithm used to precisely estimate the arrival time of a received signal. Initial processing with the sub-optimal algorithm reduces the optimal algorithm's search space by generating crude estimates for one or more multipath components of the received signal. In at least one embodiment, the sub-optimal algorithm permits identification of a number of probable multipath components of the received signal, such that the optimal algorithm may be restricted to time intervals around one or more of these probable multipath components rather than across a more expansive time window. This method allows the optimal algorithm to operate at fine time resolutions without incurring impractical computational complexity.

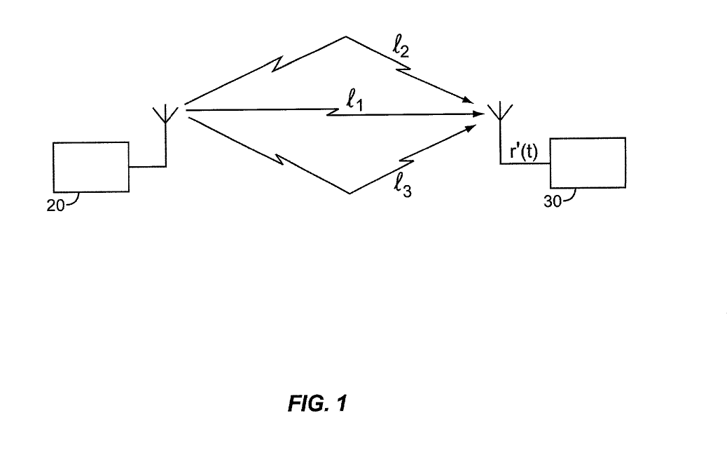

Turning now to the drawings, FIG. 1 is a diagram of a typical radio signal transmission between a transmitter 20 and a receiver 30. Because of multiple propagation paths, denoted as l₁ through l₃, the transmitted signal from transmitter 20 is received at receiver 30 as a composite of multipath signals or rays, with each ray traveling through one of the propagation paths L. This composite received signal may be denoted as r′(t). Typically, the receiver 30 filters, digitizes, and down-converts the initial received signal r′(t) to create the received signal r(t), which is a composite of the multipath signals. That is, r(t) includes multiple versions of the transmitted signal s(t), with each version having its own characteristic channel distortions affecting signal phase, amplitude, and time of arrival. In general, these multipath components complicate processing the received signal r(t) to estimate its time of arrival.

In the context of the present invention, the receiver 30 is configured based on the particular application in which it is used. For example, for use in wireless communication systems, the receiver 30 may be configured in accordance with TIA/EIA/IS-136 standards, TIA/EIA/IS-95B standards, TIA/EIA/IS-2000 standards, or any of the other common air interface standards, such as the European GSM and Wideband CDMA (W-CDMA) standards. Generally, the receciver 30 will comprise both optimal and sub-optimal processors, which may themselves comprise all or part of one or more digital signal processors (DSP) within the receiver 30.

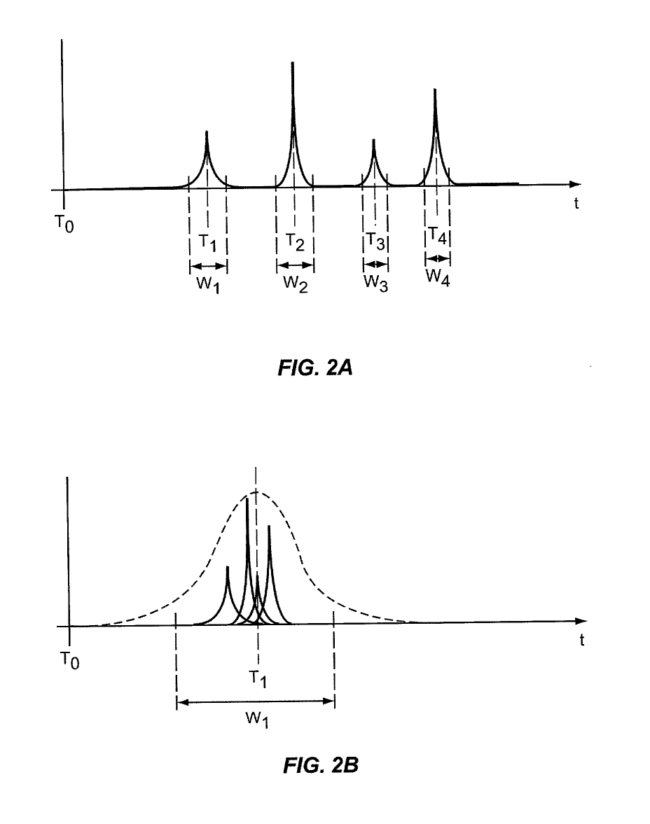

FIG. 2A illustrates an exemplary signal r(t) comprising four apparent multipath signal components corresponding to arrival times T₁ through T₄ relative to a reference time T₀. Here, the multipath signals appear to be widely spaced relative to the symbol timing used to carry information in the received signal, and sub-optimal processing enables identification of the four probable multipath components. Even so, each multipath component may in reality comprise two or more closely spaced multipath signals, which can be accurately resolved by applying the optimal algorithm to time windows defined around each one of the four probable multipath signals identified by sub-optimal processing.

References W₁ through W₄ denote the time intervals or windows defined around times T₁ through T4. As will be explained in more detail later, optimal processing is restricted to time windows W₁ through W₄ in the interest of reducing the optimal algorithm's search space. Using the optimal algorithm, the precise arrival time of the received signal r(t) within the time windows W₁ through W₄ may be more accurately fixed relative to the reference time T₀. Further, if one or more of the four apparent multipath signals is itself comprised of two or more closely spaced multipath signals not resolvable using sub-optimal processing, optimal processing will resolve the additional multipath signals within its time resolution limits, thereby allowing precise TOA estimation for one or more multipath signals within each of the time windows W₁ through W_{4.}

FIG. 2B illustrates another exemplary signal r(t), but rather than having relatively widely spaced multipath signal components, its multipath components are essentially overlapping with respect to the symbol timing of r(t). Indeed, this illustration may depict the scenario described above where one of the four apparent multipath signals shown in FIG. 2A itself comprises two or more closely spaced multipath signals. Where the degree of overlap is great, sub-optimal processing may not identify more than one general time window over which the optimal algorithm is used. Here, W₁ denotes the time window spanning the closely grouped multipath signal components of r(t). The time window W₁ may be formed by applying a threshold function to the composite received signal r(t), illustrated by the dashed-line pulse superimposed over the group of multipath signal components. Other techniques, such as least squares processing may also be used to define the span of the search windows W.

Thus, with at least some embodiments of the present invention, TOA estimation involves at least a two-step process. First, a sub-optimal algorithm generates crude estimates of arrival times of multipath components in the received signal r(t). Second, an optimal algorithm refines these crude estimates, such as by using Maximum Likelihood (ML) techniques, although in some cases a near optimal algorithm such as SEV may be used. Search spaces for the multipath signals in the second step are restricted to within the vicinity of the crude estimates.

While essentially any sub-optimal approach may be used to initially process the received signal, exemplary sub-optimal algorithms include correlation, MUSIC, and SEV. While these algorithms are subject to variation, exemplary details regarding their use with the present invention are provided below. However, it may be helpful to begin with a brief description of an exemplary mathematical model of the received signal.

Let Q copies of the transmitted signal be received by the receiver 30, where the q^{th} copy of the received signal is given as,

$${r}^{( q )} ( t ) = {\sum }_{m = 1}^{M} {α}_{m}^{( q )} s ( t - {τ}_{m} ) + {β}^{( q )} ( t ) , q ∈ \{ 1 , 2 , … , Q \} \qquad ( 1 )$$

where s(t) is the transmitted signal, τₘ is the time delay of the m^{t}h path, αₘ^{(q)} is the attenuation of the m^{th} path due to scatter characteristics and propagation through the medium, and β^{(q)}(t) is additive white Gaussian noise (AWGN). In the above model, the succession of received signals r^{(q)}(t) is considered as resulting from repeated independent experiments on % the medium. The time delays of the paths τₘ may be considered to remain unchanged for each of the Q received signals. Also, αₘ^{(q)} and αₘ^{(p)} may be considered to be uncorrelated when q≠p. The problem to be solved is to obtain the estimates of the path delays τₘ. With accurate estimates of the path delays, the TOA of the composite received signal may be accurately estimated as, for example, the TOA of its earliest multipath signal component.

Typically the received sequences are sampled so that the model considered in (1) becomes,

$${r}^{( q )} ( n ) = {\sum }_{m = 1}^{M} {α}_{m}^{( q )} s ( n - {τ}_{m} ) + {β}^{( q )} ( n ) , q ∈ \{ 1 , 2 , … , Q \} , n ∈ \{ 1 … N \} . \qquad ( 2 )$$

That is, each received sequence is N samples long. In matrix form, this may be represented as,

r^{(q)}=S·a^{(q)}+b^{(q)}, (3)

where r^{(q)} and b^{(q)} are column vectors of length N, a^{(q)} is a column vector of length M, and,

$$S = [ \begin{matrix}s ( 1 - {τ}_{1} ) & s ( 1 - {τ}_{2} ) & ⋯ & s ( 1 - {τ}_{M} ) \\ s ( 2 - {τ}_{1} ) & s ( 2 - {τ}_{2} ) & ⋯ & s ( 2 - {τ}_{M} ) \\ ⋮ & ⋮ & ⋯ & ⋮ \\ s ( N - {τ}_{1} ) & s ( N - {τ}_{2} ) & ⋯ & s ( 1 - {τ}_{M} )\end{matrix} ] , \qquad ( 4 )$$

The elements of a^{(q)} are the channel attenuation values αₘ^{(q)} where mε{1 . . . M}, and the elements of b^{(q)} are the noise values β^{(q)}(n), where nε{1 . . . N}. The columns of the matrix S are the signal vectors corresponding to each delayed multipath component of the received signal r(t).

Correlation processing represents an exemplary approach to sub-optimal processing of the received signal r(t). With correlation processing, the received signal r(t) is correlated with the transmitted signal corresponding to each one of a number of delay hypotheses, and the delay hypotheses that yield maxima in the energy of the correlator output are chosen as the path times of arrival. Thus, the correlator output may be described as,

c(τ)=s(τ)^{H}r, (5)

where s(τ)=[s(1−τ)s(2−τ) . . . s(N−τ)]^{T}, [•]^{H} indicates the Hermitian matrix, and where [•]T indicates the transpose matrix. Correlation techniques and apparatus that might be included within the receiver 30 for correlating the received signal r(t) are well understood by those ordinarily skilled in the art.

With regard to wireless communication applications, the received signal r(t) may be in essentially any form, as in Time Division Multiple Access (TDMA) systems based on, for example the TIA/EIA/IS-136 standard, or as in Code Division Multiple Access (CDMA) systems based on, for example, the TIA/EIA/IS-2000 standard. With these air interface definitions, and with others, such as the European Wideband CDMA (W-CDMA) standard, the received signal r(t), or a signal associated with the received signal, contains known information, which may be used by the receiver 30 for correlation operations. Such known information may comprise any known sequence of data or symbols, such as a training sequence or pilot symbols, or may comprise a known spreading code. In any case, the receiver 30 may base its correlation operations on this known information, and, as described earlier, may accumulate multiple copies (e.g., Q copies) of this known information by periodically receiving known information from the transmitter 20.

A modified form of the above correlation operation may be used when the correlation matrix K_{N} of the impairment process p(n) is known to not be an identity matrix, i.e., the impairment process is correlated. This form of the correlator output is given by,

c(\hat{τ})=(K_{N}⁻¹s(\hat{τ}))^{H}r, (6)

where K_{N}⁻¹ is the inverse of the noise correlation matrix K_{N}. The noise correlation matrix K_{N} in general indicates the correlation of the noise between various received samples. If the noise is uncorrelated, the matrix has non-zero values on its main diagonal only, as noted above.

The correlation matrix of the received signal sequence (samples of r(t)) is given by,

K=E(r·r^{H})=SPS^{H}+K_{N}, (7)

where P is the correlation matrix of the received multipath components of r(t) whose elements are given by Pᵢⱼ=E(αᵢ·a*ⱼ). The matrix K is estimated as K by averaging the Q received copies of the received signal. Thus, the estimated correlation matrix is given as,

$$\hat{K} = \frac{1}{Q} {\sum }_{q = 1}^{Q} r ( q ) \cdot {r ( q )}^{H} , \qquad ( 8 )$$

As an alternative to the exemplary correlation process details, sub-optimal processing of the received signal may employ the MUSIC algorithm, which entails finding the Eigen values and Eigen vectors of the matrix \hat{K} as follows,

\hat{K}V=K_{N}VD, (9)

where the columns of V contain the Eigen vectors of \hat{K} and D is a diagonal matrix given by D=diag(λ₁, . . . , λ_{N}), where λi are the corresponding Eigen values. The MUSIC algorithm thus estimates the delays of the M paths for of the multipath components of the received signal r(t) as the M maxima of the function,

F_{MUSIC}(τ)=[s(τ)^{H}V_{N}V_{N}^{H}s(τ)]⁻¹, (10)

where V_{N} is the matrix containing the N−M columns of V that correspond to the noise Eigen vectors of V, and s(τ) is as defined earlier in (5). The noise Eigen vectors of V are the columns of V that are orthogonal to the signal vectors that make up the received signal r(t). The delays of the multipath signal components in r(t) are estimated as the delays τᵢ that correspond to the peaks of the function given above in (10).

The MUSIC algorithm may thus be summarized by the following steps:

(a) receive Q copies of the sampled received signal r(t) given by (2);

(b) form an estimate k of the correlation matrix K as given by (8);

(c) find the Eigen values from the matrix D and the Eigen vectors V of the matrix \hat{K} according to (9);

(d) estimate the number of multipath components \hat{M} from the Eigen values in the diagonal of the matrix D, where the high Eigen values correspond to the signal components;

(e) collect a set of noise Eigen vectors in a matrix V_{N}, where the noise Eigen vectors are the Eigen vectors in V that correspond to the low Eigen values in the diagonal elements of D;

(f) for each hypothesis of a delay value, τε(τₘᵢₙ . . . τₘₐₓ), compute the value of the function F_{MUSIC}(τ) as given by (10); and

(g) find the delay hypotheses \hat{τ}ₘ for which the function _{F}_{MUSIC}(τ) achieves its \hat{M} local maximum values, where the M corresponding delays (τ₁,τ₂, . . . ,τ_{\hat{M}})are the estimates of the times of arrival for the multipath components of r(t).

As the MUSIC algorithm involves finding the M maxima of a one-dimensional function instead of the maximum of an M-dimensional function, the MUSIC algorithm has significantly lower complexity than that of the optimal, Maximum Likelihood approach (ML).

The SEV approach involves the maximization of the M-dimensional function,

F_{SEV}(τ₁, . . . , τ_{M})=Tr(Π₀K_{N}V_{S}WV_{S}^{H}), (11)

where Π₀=(1−Π_{S}), with Π_{S}=SΨ⁻¹S^{H}K_{N}⁻¹ and Ψ=S^{H}K_{N}⁻¹S, I is an identify matrix, V_{S} is a matrix whose columns contain the columns from the matrix V that correspond to the M signal components of r(t),i.e., the signal Eigen vectors, and W is a weighting matrix. It may be shown that the optimal weighting matrix is given by,

W=[D_{M}−I]²D_{M}⁻¹, (12)

with D_{M}=diag(λ1, . . . , λ_{M}), where “diag” indicates a diagonal matrix, and where λᵢ are the Eigen values corresponding to the signal Eigen vectors in consideration.

The SEV approach may be summarized in the following steps:

(a) receive Q copies of the sampled received signal r(t) as given by (2);

(b) form an estimate \hat{K} of the correlation matrix K as given by (8);

(c) find the Eigen values from the matrix D and the Eigen vectors V of the matrix \hat{K} according to (9);

(d) collect a set of signal Eigen vectors in a matrix V_{S}, where the signal Eigen vectors are the Eigen vectors in V that correspond to the M high Eigen-values in the diagonal elements of D;

(e) compute the weighting matrix Was given by (12);

(f) for each hypothesis of the delays \hat{τ}_{M} of the M paths, compute the values of F_{SEV}(τ₁,τ₂, . . . , τ_{M})as given by (11); and

(g) find the hypothesis for which the function F_{SEV} achieves its maximum value, where the corresponding delays (τ₁,τ₂, . . . , τ_{M}) are the estimates of the times of arrival of the M multipath components of r(t).

In the SEV approach, an estimate of the number of multipath components may be made from the Eigen values. However, where M is not known, it must be estimated to set the dimension of the F_{SEV} function, which must be maximized over the M estimated paths. The complexity of the SEV algorithm may approach that of the Maximum Likelihood (ML) optimal approach, which is detailed below.

With the multistage TOA estimation techniques used in at least some embodiments of the present invention, sub-optimal processing, as exemplified above, reduces the dimensionality of the search space within which optimal (e.g., ML) processing is applied. This yields the TOA estimation accuracy close to that obtainable only with optimal algorithms, yet reduces the aggregate complexity of the overall TOA estimation process.

A more detailed look at optimal processing based on the ML approach begins with a definition of the ML function. After defining Ψ=S^{H}K_{N}⁻¹S, the ML function is given as,

F_{ML}(τ₁,τ₂, . . . , τ_{M})=Tr(Π_{S}\hat{K}K_{N}⁻¹), (13)

where Tr(•) is the trace operator and Π_{S}=SΨ⁻¹S^{H}K_{N}⁻¹, which is an N×N projection matrix onto the subspace spanned by the signal vectors in the columns of the matrix S.

This multistage sub-optimal/optimal approach may be summarized in the following steps:

(a) process the received signal using a relatively low-complexity algorithm (as compared to ML processing complexity) to obtain initial estimates of arrival times for one or more probable multipath components of the received signal, with exemplary techniques including correlation and MUSIC processing as outlined above; and

(b) apply optimal processing such as ML based TOA estimation within the reduced search space or spaces corresponding to the initial delay estimates identified during the initial processing.

Viewed another way, optimal processing compares estimates of the received signal against what was actually received, where the estimate of the received signal is based on combinations of the variables affecting the received signal. The combination of variables resulting in the estimate with the lowest error is taken as the most correct. That is, the estimate corresponding to that set or combination of variables represents the “maximum likelihood” among all of the estimates.

Because ML processing considers all combinations of variables, its complexity increases rapidly with the number of variables involved. Assume that the number M of multipath signal components in a received signal is known. The ML processor must compute an estimate of the received signal for all possible combinations of time delay, phase, and magnitude for all M multipath signals. If the number of multipath signals is not known, the ML processor must also consider all possible values of M, or at least must consider all possible number of multipath signals within a defined upper limit for M.

Obviously, any pre-processing that restricts this variable space can result in significant reductions in the total number of optimal processing calculations that must be performed. Within the context of the present invention, sub-optimal processing can, for example, identify the number of likely delay components within the received signal, and generate rough or initial time delay estimates for these identified components.

Hence, the search space for optimal processing and thus computational complexity may be reduced by restricting the time windows for the initial delay estimates τₘ to a window of time defined by τₘ±δₘ, where δₘ is much smaller than the spacing between the delay estimates \hat{τ}ₘ.

This approach is illustrated in FIG. 2A, where the time windows W1 through W4 are defined around the estimated multipath delays of the received signal r(t). Here, the parameter δₘ defines the size of the ML search window around the vicinity of each delay estimate \hat{τ}ₘ. Each delay estimate \hat{τ}ₘ may use a different value for the δₘ parameter, and the span of the search window may be further adjusted based on the magnitude of the output and the shape of the output in the vicinity of the local maximum for the estimated m^{th} path of the received signal.

Where two time delay estimates satisfy (\hat{τ}ᵢ−\hat{τ}ⱼ)<t, where t is a defined time difference threshold value, optimal algorithm search spaces may be modified through hypotheses including a third multipath component with a delay \hat{τ}ₖ such that three paths within a delay window (\hat{τ}ᵢ−δᵢⱼ)<(\hat{τ}ⱼ+δᵢⱼ) are tested during the optimal processing phase. That is, hypotheses within this range are tested using an ML or possibly a SEV approach to further refine the TOA estimates. Thus, when two multipath signal components occur very close to each other in time within the received signal, a third multipath component is considered in the vicinity of the two closely space multipath components. The quantity δᵢⱼ is a parameter that defines the time span of the search window that will be used to search for the presumed third path within the vicinity of the closely spaced i^{th} and j^{th} paths.

Where an estimate of the slope of the function F_{MUSIC} (i.e., equation (10)) is low in the vicinity of a peak at a time delay \hat{τ}ₘ, this indicates a multipath component in the received signal r(t). At such points, optimal algorithm search spaces may be modified by hypothesizing second multipath components within a delay given as \hat{τ}ₘ±δₘ. This allows the optimal search algorithm to search for additional multipath components within a restricted search space around the crudely identified multipath components revealed during sub-optimal processing.

Thus, with the time window restriction, the ML algorithm may be set to test hypotheses of the various combinations of multipath signal component delay, amplitude, and phase, across a set of defined points within the search window or windows. The resolution of the time positions within the search windows at which ML hypotheses are evaluated for error with respect to the actual received signal may be set depending upon the time resolution requirements placed on TOA estimation. Higher resolutions require subdividing the search windows for ML algorithm processing into finer subdivisions of time. For example, the ML algorithm may be set to test hypotheses within one or more search windows at time positions spaced apart at one-tenth the received signal's basic symbol timing for accurate TOA estimation. Where less accuracy is required, the time positions may be set more coarsely.

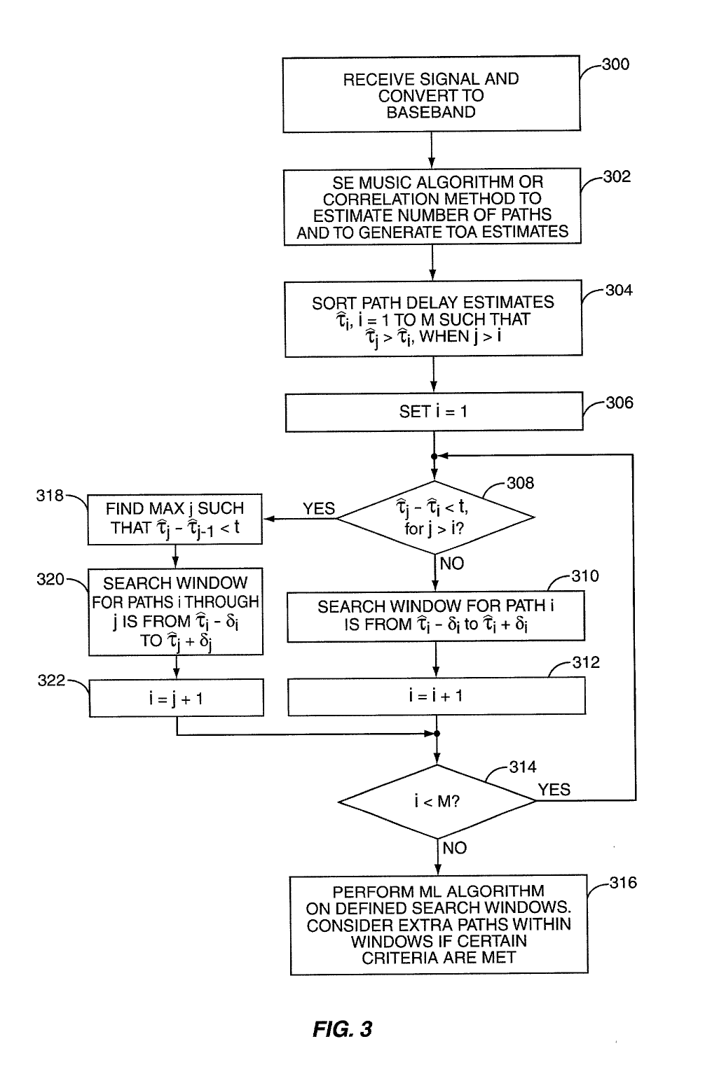

FIG. 3 illustrates exemplary flow logic for combining sub-optimal and optimal algorithms in TOA estimation. Processing begins with reception of the received signal r′(t), which is converted to baseband to form the sampled received signal r(t) (step 300). The sampled received signal is the processed using, for example, the MUSIC algorithm or the correlation method to identify one or more multipath signal components of the received signal (step 302). This pre-processing of the received signal provides crude estimates of the actual multipath components in the received signal, and serves to reduce the search space used in optimal algorithm processing. Here, sub-optimal processing has produced M path estimates.

Next, the path delays of the multipath signal components identified in sub-optimal processing are sorted in ascending order (step 304). That is, the earliest TOA is placed first in the sort order. A path index variable i is then set to the first path in the sort order (step 306). Path pairs that are adjacent in time based on the sort order are then evaluated to determine their proximity to each other. This is in keeping with the earlier point regarding hypothesizing additional multipath components within the vicinity of two closely spaced multipath components identified during sub-optimal processing. Specifically, the time difference between the i^{th} multipath component delay and the next multipath component delay in the sort order (i.e., the i^{th}+1 or j^{th} delay) is evaluated to determine whether it is less than the defined time difference threshold t (step 308).

If the time difference between the i^{th} multipath component delay and the next multipath component delay in the sort order exceeds the threshold t, the optimal algorithm search window Wᵢ for the i^{th} multipath component delay is defined as \hat{τ}ᵢ-δᵢ to \hat{τ}ᵢ+δᵢ, where δᵢ is a defined time span that may be set or adjusted on a per-delay basis, depending on, for example, the slope of the output in the vicinity of the corresponding i^{th} multipath component, and where \hat{τ}ᵢ is the delay relative to some reference time (e.g., T₀) of the i^{th} component's estimated delay time (step 310). The component index variable i is then incremented (step 312) and evaluated to determine if there are additional multipath components as identified by sub-optimal processing (step 314). If not, optimal processing begins within the restricted search windows. If additional components remain, the window restriction process is applied to the delay time of the next component in the sort order (steps 308+).

If, however, the time difference between the delay corresponding to the i^{th} component and the i^{th}+1 component does not equal or exceed the threshold t (step 308), the j^{th} component (j>1) at which the corresponding time delay satisfies the equation \hat{τ}ⱼ−\hat{τ}ⱼ₋₁≧t is identified (step 318). Essentially, this entails incrementing the index j from j=i+1 until the time difference between the j^{th} and (j−1)^{th} multipath component delays exceeds the defined threshold t. Then, an optimal algorithm time window is defined that spans the ith through the jth time delays as \hat{τ}ᵢ−\hat{τ}ⱼ+δⱼ, where \hat{τ}ᵢ is the delay time of the i^{th} component and \hat{τ}ⱼ is the delay time of the j^{th} component (step 320). Note that this time interval includes one or more delay times for multipath components having delays greater than the i^{th} delay but less than the j^{th} delay. After defining this search window, the sort index i is incremented to one past the j^{th} index determined in step 318 (step 322), and processing continues (step 314+).

While combining sub-optimal and optimal processing yields the most accurate received signal TOA estimates, there may be some instances where the required accuracy in TOA estimation does not necessitate optimal algorithm processing. In these cases, sufficient accuracy may be obtained by iterative processing of the received signal using a sub-optimal approach. For example, the correlation method may be used iteratively in a successive cancellation approach. With successive cancellation, the multipath signal component or components identified in each iteration are treated as noise and cancelled for the next iteration. With each cancellation, the actual multipath components of the received signal are revealed with successively better resolution.

In more detail, at the beginning of each iteration a new noise correlation matrix K′_{N} is calculated as K′_{N}=K_{N}+′P′S′^{H}, where the matrix S′ has columns that are the signal components at the estimated time delays from the previous iteration. This effectively treats the detected signal vectors (i.e., the vectors corresponding to the detected multipath components of the received signal) as noise. The matrix P′ is the correlation matrix of the channel for the corresponding received signal paths. If this matrix is not known, it may be estimated or chosen as the identify matrix.

Then, for the next successive iteration, the sub-optimal algorithm, such as the MUSIC or correlation algorithm, is re-executed as previously described, with K′_{N} used rather than K_{N}. The output of each iteration may be used to determine if one or more additional iterations are needed. For the correlation method, the energy at the output of the correlator is used to determine whether additional paths may be present. For the MUSIC algorithm, the sum of the Eigen values computed at each iteration is used to decide whether additional paths may be present. In either case, if the metric is above a certain threshold indicating that signal energy from more paths is present, another iteration is performed. If the metric falls below the specified threshold, further iterations are deemed unnecessary, and the multipath component detected that has the lowest path delay is chosen as the first path. The TOA estimate for this first path may be taken as the TOA estimate for the received signal.

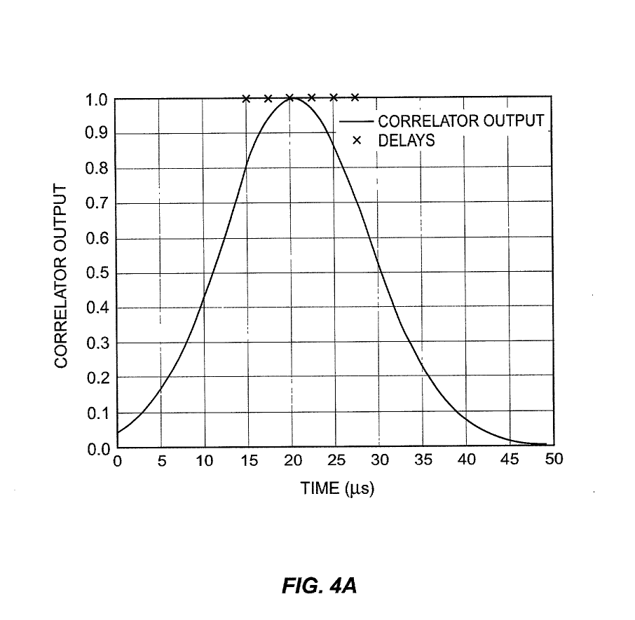

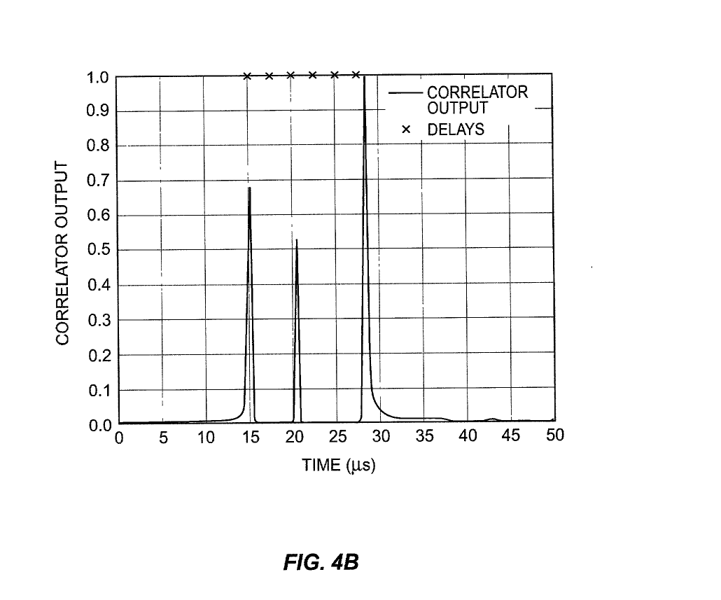

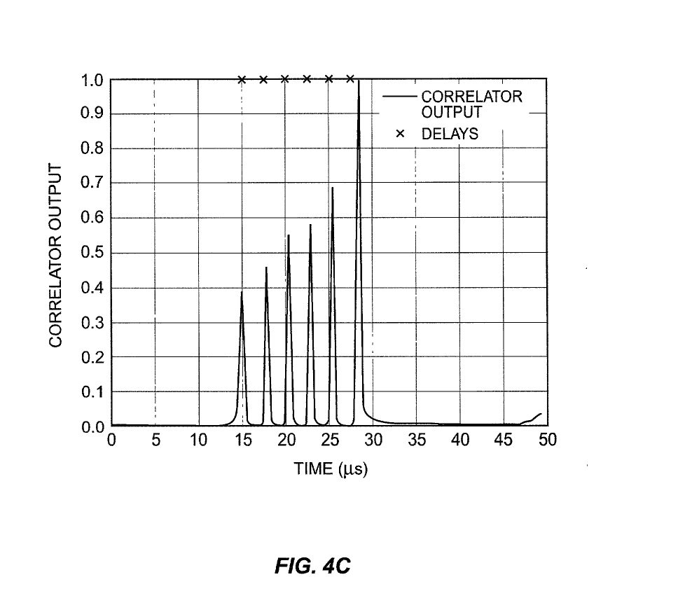

FIGS. 4A-4C illustrate iterative correlation as applied to a received signal having six true multipath components. The “X” markers along the top grid in the figures identify the true time delays of the multipath delays relative to the zero point on the horizontal axis. FIG. 4A illustrates the initial correlator output for the received signal, which indicates a single, rather broad correlation peak. This response is similar to that depicted in FIG. 2B, where the delay separation between multipath components of the received signal were too small to resolve in a single-pass sub-optimal approach.

With the iterative approach however, a delay time corresponding to the center of the single correlation response peak is assumed, and the noise matrix K_{N} is updated such that the presumed multipath signal component corresponding to this delay time is cancelled. Such cancellation reveals additional detail regarding the true nature of the multipath components in the received signal, as illustrated in FIG. 4B, which depicts the correlator output on the second iteration. With multipath component identified in the first iteration cancelled, this second iteration reveals three correlation peaks. The presumed multipath components corresponding to these three peaks are then cancelled from the received signal (e.g., treated as noise components) by adjusting the noise matrix K_{N} used in correlation operations.

FIG. 4C illustrates the path delay estimates on the third iteration after two rounds of cancellation. Here, the approximations of the six true multipath components of the received signal are more clearly revealed, and are positioned at relative delay times (refer to the “x” markers) at or close to the actual delay times of the true multipath components. It may be that in some applications, these delay time approximations arrived at iteratively are accurate enough. In this case, the TOA estimate of the received signal may be, for example, taken as the arrival time of the earliest multipath component illustrated in FIG. 4C. If these TOA estimates are not sufficiently resolved for the purpose at hand, they may be further refined by optimally searching time windows about one or more of them.

That is, optimal processing may be combined with iterative sub-optimal processing. Such a combination may have advantages where optimal processing will be used at high time resolutions, such as less than one-tenth of the symbol timing used in the received signal. At such high resolutions, optimal searching even in reduced search spaces is computationally intensive, and entering optimal processing with strictly reduced search windows is advantageous.

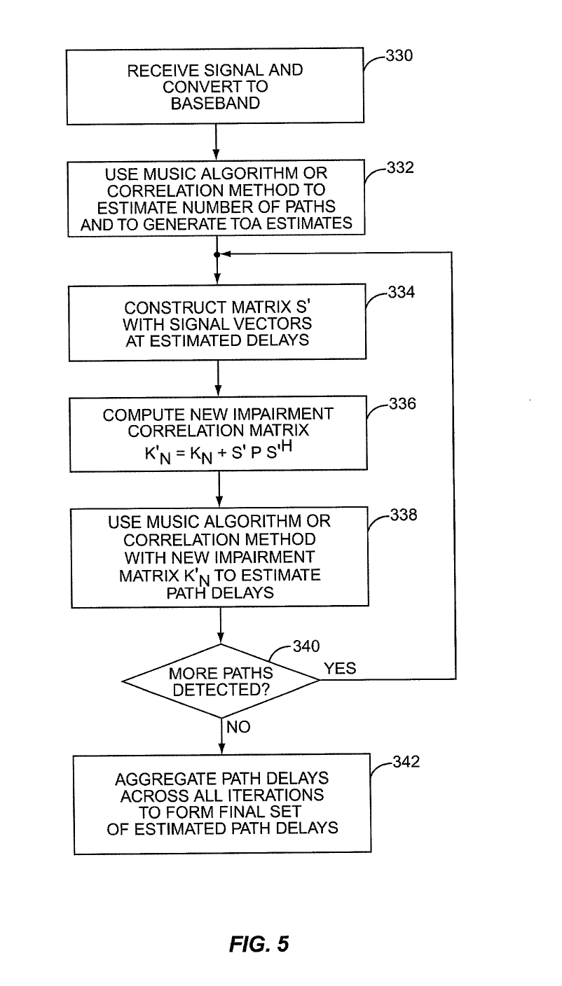

FIG. 5 illustrates exemplary flow logic for iterative processing. Operations begin with converting the received signal r′(t) to baseband to form the received signal r(t) (step 330). Then, sub-optimal processing, such as by MUSIC or by correlation, is applied to the received signal to estimate the number of multipath components in r(t), and to generate TOA estimates corresponding to these estimated paths (step 332).

The matrix S′ is estimated using the signal vectors at the estimated delays (step 334), and a new impairment correlation matrix (noise matrix) is calculated as K′_{N}=K_{N}+S′P′S′^{H} (step 336). Then, the sub-optimal algorithm is applied in a next iteration using the new impairment correlation matrix K′_{N} to estimate multipath component path delays (step 338). If more paths are detected in this current iteration (step 340), then processing repeats for the next iteration using the adjusted impairment correlation matrix K′_{N} (steps 334+). If no additional paths were detected on the current iteration (step 340), processing continues with aggregating path delays across all iterations to form a final set of estimated path delays (step 342).

Thus, TOA estimation may be based on a sub-optimal/optimal approach, an iterative sub-optimal approach, and an iterative sub-optimal/optimal approach. The above discussion provides details regarding exemplary approaches for these various combinations of sub-optimal and optimal received signal processing. In general, the present invention reduces the complexity of highly accurate TOA estimation using optimal algorithm approaches by preceding optimal algorithm processing with sub-optimal algorithm processing. This two-step approach may also be used to reduce the complexity of the SEV-based approach to TOA estimation for the multipath components of the received signal. Further, in some instances, iterative sub-optimal processing may obviate the need for subsequent optimal processing where TOA estimate accuracy requirements are not too stringent.

Obviously, the present invention is subject to much variation. Thus, the exemplary details above should not be construed as limiting the present invention. Rather the present invention is limited only by the scope of the claims below, and the reasonable equivalents thereof.

What is claimed is:

1. A method of determining an arrival time of a received signal comprising two or more multipath components, the method comprising:
using a sub-optimal estimation algorithm to identify one or more time windows; and
determining a time estimate for one or more multipath components of said received signal by using an optimal search algorithm bounded by said time windows.

2. The method of claim 1 wherein using a sub-optimal estimation algorithm to identify one or more time windows comprises:
processing said received signal to identify an approximate time estimate for one or more multipath components of said received signal; and
defining said one or more time windows as one or more spans of time encompassing a range of time around said approximate time estimates, such that said optimal search algorithm operates within a reduced search space.

3. The method of claim 1 further comprising:
assuming a maximum number of multipath components for at least one of said one or more time windows; and
restricting said optimal search algorithm to estimation trials involving no more than said maximum number of multipath components for said at least one time window.

4. The method of claim 1 wherein using a sub-optimal estimation algorithm to identify one or more time windows comprises processing at least a portion of said received signal using a Multiple Signal Identification and Classification (MUSIC) algorithm.

5. The method of claim 1 wherein using a sub-optimal estimation algorithm to identify one or more time windows comprises processing at least a portion of said received signal using a correlation algorithm.

6. The method of claim 5 further comprising iteratively applying said correlation algorithm to said received signal to better resolve one or more correlation peaks in said received signal corresponding to said one or more multipath signals comprising said received signal.

7. The method of claim 6 further comprising restricting said optimal search algorithm to time windows defined around said one or more correlation peaks.

8. The method of claim 1 wherein using a sub-optimal estimation algorithm to identify one or more time windows comprises processing at least a portion of said received signal using a Signal Eigen Vector (SEV) algorithm.

9. The method claim 1 wherein said optimal algorithm comprises a maximum likelihood estimation algorithm.

10. A method of determining an arrival time for a received signal having multipath signal components, the method comprising:
processing said received signal using a sub-optimal algorithm to identify one or more time intervals corresponding to one or more probable multipath signal arrival times; and
generating a time estimate for said received signal based on resolving said one or more probable multipath signals within said one or more time intervals using an optimal search algorithm restricted to said one or more time intervals.

11. The method of claim 10 wherein resolving said one or more probable multipath signals within said one or more time intervals using an optimal search algorithm restricted to said one or more time intervals comprises:
defining a plurality of time positions across at least one of said time intervals, wherein said time positions are spaced apart according to a desired time resolution for resolving said arrival time of said received signal; and
applying said optimal search algorithm to said plurality of time positions to identify a Maximum Likelihood (ML) time position within said time interval.

12. The method of claim 10 further comprising assuming a maximum number of multipath signals for said received signal for use by said optimal search algorithm if processing said received signal with said sub-optimal algorithm does not yield a probable number of multipath signals.

13. The method of claim 10 wherein processing said received signal using a sub-optimal algorithm to identify one or more time intervals corresponding to one or more probable multipath signal arrival times comprises:
identifying one or more received signal peaks; and
applying a threshold function to said one or more peaks to define said one or more time intervals.

14. The method of claim 10 wherein processing said received signal using a sub-optimal algorithm to identify one or more time intervals corresponding to one or more probable multipath signal arrival times comprises correlating known information with at least a portion of said received signal.

15. The method of claim 14 wherein correlating known information with at least a portion of said received signal comprises correlating a sequence of known values with a sequence of said received signal transmitted as said sequence of known values.

16. The method of claim 15 further comprising iteratively correlating said received signal to better resolve correlation peaks corresponding to at least some of said multipath signals comprising said received signal.

17. The method of claim 16 wherein iteratively correlating said received signal to better resolve correlation peaks corresponding to at least some of said multipath signals comprising said received signal comprises canceling correlation peaks identified in a previous correlation iteration in each successive correlation iteration until no new correlation peaks in said received signal are identified.

18. The method of claim 16 further comprising restricting said optimal search algorithm to a time window around at least one of said correlation peaks identified by said iterative correlation.

19. A method of determining an arrival time for a received signal having multipath signal components, the method comprising:
processing said received signal to identify one or more multipath components;
canceling said identified multipath components; and
repeating said processing and canceling steps iteratively until the multipath components identified at a previous iteration substantially match the multipath components identified at the current iteration.

20. The method of claim 19 wherein processing said received signal to identify one or more multipath components comprises processing said received signal using a sub-optimal processing algorithm.

21. The method of claim 20 wherein processing said received signal using a sub-optimal processing algorithm comprises using a MUSIC algorithm to process said received signal.

22. The method of claim 20 wherein processing said received signal using a sub-optimal processing algorithm comprises using a correlation algorithm to process said received signal.

23. The method of claim 19 wherein canceling said identified multipath components comprises treating the identified multipath components as noise, which noise is filtered during processing said received signal in the next iteration.

24. The method of claim 23 wherein treating the identified multipath components as noise comprises updating a noise correlation matrix at the beginning of each processing iteration based on the identified multipath components from the previous iteration, wherein said noise correlation matrix is used to identify multipath components in each processing iteration of said received signal.

25. A receiver operative to estimate a time of arrival of a received signal, the receiver comprising:
a sub-optimal algorithm processor to process said received signal using a sub-optimal algorithm to generate crude estimates for one or more multipath components of said received signal; and
an optimal algorithm processor to refine said crude estimates for said one or more multipath components of said received signal, such that an arrival time of said received signal may be estimated.

26. The receiver of claim 25 wherein said sub-optimal algorithm processor comprises a MUSIC algorithm processor.

27. The receiver of claim 25 wherein said sub-optimal algorithm processor comprises a correlation algorithm processor.

28. The receiver of claim 25 wherein said sub-optimal algorithm processor comprises a Signal Eigen Vector (SEV) algorithm processor.

29. The receiver of claim 25 wherein said optimal algorithm processor comprises a Maximum Likelihood (ML) algorithm processor.

30. The receiver of claim 25 wherein said receiver comprises a wireless receiver configured for use in a wireless communication network.

31. The receiver of claim 25 wherein said sub-optimal algorithm and optimal algorithm processors comprise at least one DSP programmed to perform sub-optimal and optimal processing of said received signal.
